(19) United States
(12) Patent Application Publication
(10) Pub. No.: US 2020/0132021 A1
(43) Pub. Date: Apr. 30, 2020

(54) GAS INJECTION VALVE FOR INJECTING A COMBUSTIBLE GAS INTO AN INTERNAL COMBUSTION ENGINE, INTERNAL COMBUSTION ENGINE HAVING SUCH A GAS INJECTION VALVE, AND METHOD FOR OPERATING SUCH AN INTERNAL COMBUSTION ENGINE

(71) Applicant: MTU FRIEDRICHSHAFEN GMBH, Friedrichshafen (DE)

(72) Inventors: Friedrich KÖSKEMEIER, Markdorf (DE); Florian JOOS, Ravensburg (DE)

(21) Appl. No.: 16/607,831

(22) PCT Filed: Apr. 5, 2018
(86) PCT No.: PCT/EP2018/058800

§ 371 Date: Oct. 24, 2019

(30) Foreign Application Priority Data
Apr. 28, 2017 (DE) 10 2017 207 276.8

(51) Int. Cl. F02M 21/02; F02D 19/02; F02D 41/00; F16K 1/52

(52) U.S. Cl. CPC F02M 21/0251; F02D 19/024; F16K 1/523; F02M 21/0263; F02M 21/0278; F02D 41/0027

(57) ABSTRACT

A gas injection valve for injecting a combustible gas into an internal combustion engine, comprising a valve element, which can be moved between closed position and an open position, the open position being defined by a maximum stroke of the valve element. The maximum stroke of the valve element can be adjusted during operation of the gas injection valve.

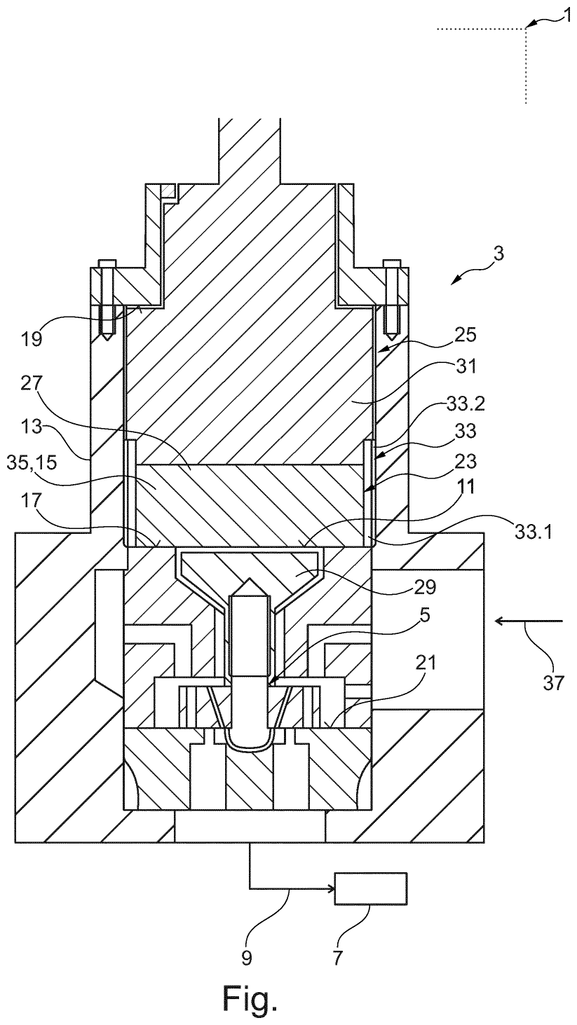

The invention relates to a gas injection valve for injecting a combustion gas into an internal combustion engine, an internal combustion engine having such a gas injection valve, and a method for operating an internal combustion engine having such a gas injection valve.

A gas injection valve of the type here discussed is known, for instance, from German Offenlegungsschrift DE 10 2014 207 182 A1, in which a gas injector for directly injecting a gaseous medium into a combustion chamber of an internal combustion engine is disclosed. A gas injection valve of the type which is here discussed can, however, also be designed to inject a combustion gas into a charging path of an internal combustion engine, whether by way of a multipoint injection or within a single-point injection into an intake manifold separately assigned to a combustion chamber of the internal combustion engine. Such a gas injection valve has a valve member, which is displaceable between a closed position and an open position defined by a maximum stroke of the valve member, wherein, in known gas injection valves, a combustion gas quantity which is fed to the internal combustion engine can be varied merely by the choice of energization times for actuation of the gas injection valve out of the closed position into the open position. As an additional parameter for the adjustment of the injected combustion gas quantity can serve a primary pressure upstream of the gas injection valve in a combustion gas line, in which case, however, a complex pressure regulation for the combustion gas line is necessary. Conventional gas injection valves therefore have the drawback that they are difficult to adjust between a no-load operation, on the one hand, and a full-load operation, on the other hand, and can scarcely be designed to suit both operating modes. Since, namely, the energization period may not be chosen to be desirably short, because otherwise no complete valve opening is realized and the valve member moves only within the ballistic range, it is often not possible at idle to ascribe an appropriately small combustion gas quantity. In particular, if very small quantities are ascribed, a quantity variation is so large that smooth idle running is not possible. Nor can the gas injection valves here be designed as desired, since, in full-load operation, they have to ensure a specific maximum throughput of combustion gas.

The object of the invention is to provide a gas injection valve, an internal combustion engine having such a gas injection valve, and a method for operating such an internal combustion engine, in which said drawbacks do not arise.

The object is achieved by the provision of the subjects of the independent claims. Advantageous embodiments emerge from the subclaims.

The object is in particular achieved by the provision of a gas injection valve of the previously discussed type, which is distinguished by the fact that the maximum stroke of the valve member is adjustable during operation of the gas injection valve. It is thereby possible to perform the adjustment of the combustion gas quantity not, or at least not only by the choice of energization times of the gas injection valve, but in particular, if need be exclusively, by adjustment of the maximum stroke. There is thus provided, in particular, an additional parameter, which can be used for the operation of an internal combustion engine. This enables not only a defined no-load operation with low quantity variation, in particular by adjustment of a minimum maximum stroke, as well as a full-load operation, in particular upon setting of a maximal maximum stroke, but also an optimization of the energization times for actuation of the gas injection valve to gas-dynamic conditions in the internal combustion engine, in particular in order to optimize a mixture formation in at least one combustion chamber of the internal combustion engine. Since a further parameter for adjusting the injected combustion gas quantity is available, the primary pressure in the combustion gas line can be dispensed with as a parameter for the quantity control. Thus there is no longer a need for a complex gas pressure regulation, rather the use of a simple fixed pressure regulator for the combustion gas line is sufficient, wherein in this combustion gas line in particular a constant primary pressure can be adjusted. Furthermore, ageing effects, for instance an increase in the through-flow of the gas-injection valve over its life, can be compensated, preferably offset, by suitable adjustment of the maximum stroke.

By a closed position of the valve member is here understood a functional position in which a flow path for combustion gas is shut off by the gas injection valve. The valve member is preferably biased into the closed position and can be displaced counter to this bias into the open position. By an open position is correspondingly understood a functional position of the valve member in which it opens up a flow cross section, defined by the maximum stroke, for combustion gas through the gas injection valve. The gas injection valve is in particular designed to, in the open position, inject combustion gas into the internal combustion engine. By a maximum stroke is here understood a stroke which can be maximally effected by a displacement mechanism for the valve member and which can be defined, for instance, by a stop for the valve member. This should be differentiated from the fact that the valve member, by the displacement mechanism assigned thereto, does not necessarily have to be opened maximally wide, thus up to the maximum stroke. Rather, it is also possible to choose the energization or actuation times for the gas injection valve such that the valve member does not cover the full distance up to the maximum stroke, and hence to the defined open position, wherein it can be moved, for instance, within a ballistic range. By contrast, the maximum stroke denotes, with the displacement mechanism, in the current setting of the maximum stroke, the widest possible opening of the gas injection valve. Correspondingly, by the defined open position is understood a position of the valve member that is maximally open during the defined, currently set maximum stroke, wherein, in particular, the displacement of the valve member is limited. In the open position, no further displacement of the valve member by the displacement mechanism beyond the open position is thus possible.

That the maximum stroke is adjustable during operation of the gas injection valve signifies, in particular, that this stroke, during the operation of an internal combustion engine comprising the gas injection valve, preferably on a time scale of less than 1 second, in particular on a time scale which allows a fully transient adjustment of the maximum stroke during operation of the internal combustion machine, is variable. The maximum stroke is thus by no means adjustable only in the production, adjustment or maintenance of the gas injection valve, but during the operation thereof, so that it can be used as a parameter for the control or regulation of the internal combustion engine.

According to a refinement of the invention, it is provided that the gas injection valve has a first stop, against which the valve member, in the open position, butts. The first stop here defines the maximum stroke. The first stop is displaceable, viewed in the stroke direction of the valve member, relative to a housing of the gas injection valve—which housing can be arranged in particular in an engine-mounted manner on an internal combustion engine—in particular in order to adjust the maximum stroke. The first stop is here displaceable, in particular, between a minimum position, which corresponds to a minimal maximum stroke, and a maximum position, which corresponds to a maximal maximum stroke. Via the variation or adjustment of the first stop, the maximum stroke can thus be adjusted. The valve member preferably butts in the open position against the first stop, so that the position thereof defines the widest possible opening of the valve and hence, at the same time, the open position and the maximum stroke. By the first stop can be ensured that the valve member opens in a constantly reproducible manner, wherein in particular the open position, in each setting of the maximum stroke, is precisely defined and reproducible.

According to a refinement of the invention, it is provided that the first stop is disposed on a stop member, wherein the stop member is displaceable between a second stop, arranged in a spatially fixed manner relative to the housing of the gas injection valve, and a third stop, arranged in a spatially fixed manner relative to the housing. The second stop here defines a minimum position for the first stop, and thus, at the same time, the minimal maximum stroke. The third stop defines, in particular, a maximum position for the first stop, and hence, at the same time, the maximal maximum stroke. The stop member can here be displaced in a defined and reproducible manner between the second stop and the third stop, preferably into a plurality of discrete or continuous positions, so that, correspondingly, also the maximum stroke between the minimal maximum stroke and the maximal maximum stroke can assume a plurality of discrete or continuous values.

Preferably, the gas injection valve has a fourth stop for the valve member, wherein the fourth stop defines a sealing seat of the valve member, against which the latter, in the closed position, butts. In particular, the valve member, in the closed position, is pressed, preferably under pretension, against the fourth stop.

According to a refinement of the invention, it is provided that the gas injection valve has a first displacement mechanism, which is designed to displace the valve member between the closed position and the open position. The first displacement mechanism is preferably configured as an electromagnetic displacement mechanism, wherein it can have, in particular, an electromagnet, which cooperates with a magnetic armature or magneto armature. Preferredly, the valve member is here configured as an armature or disposed on the armature, wherein the electromagnet is configured, and arranged relative to the valve member, such that it can displace the valve member from the closed position into the open position whenever it is energized. This enables a simple, precise and reproducible actuation of the gas injection valve, in particular by pre-specification of energization or actuation times.

The gas injection valve preferredly has a second displacement mechanism for the displacement of the first stop, in particular of the second stop. The second displacement mechanism is preferredly designed to displace the stop member between the minimum position and the maximum position. With the aid of the second displacement mechanism, it is preferredly possible to adjust the maximum stroke in a reproducible, precise and/or automated manner.

According to a refinement of the invention, it is provided that the second displacement mechanism has an actuatable rotary drive, preferably an electric motor, which cooperates with a thread, in particular with a fine-pitch thread, for the adjustment of the first stop. In this way, the position of the first stop is adjustable in a simple, precise and reproducible manner.

According to a refinement of the invention, it is provided that the gas injection valve has an adjusting element, which is displaceable jointly with the stop member and which has a first thread which meshes with a second thread arranged in a spatially fixed manner relative to the housing of the gas injection valve, wherein the rotary drive is designed and arranged to rotationally drive the adjusting element. The first thread is preferably an external thread. The second thread is preferably an internal thread. Preferably, both the first thread and the second thread are respectively fine-pitch threads. Since the rotary drive rotationally drives the adjusting element, the latter can with its first thread mesh with the second thread, and thus effect a displacement of the stop member in the stroke direction of the valve member. This can happen, in particular in the use of a fine-pitch thread, in a very precise and reproducible manner. The rotary drive is, in particular, operatively connected to the adjusting element in order to rotationally drive this same. It is preferredly provided that the adjusting element is the stop member or part of the stop member. In particular, the stop member can be configured as an adjusting element and have the first thread, or it can be connected to the adjusting element or be part of the adjusting element. In this way, a very simple construction of the gas injection valve, combined with, at the same time, a cost-effective, precise and reproducible design, is possible.

The object is also achieved by the provision of an internal combustion engine which has a gas injection valve according to one of the previously described illustrative embodiments. In connection with the internal combustion engine, in particular the advantages which have already been described in connection with the gas injection valve are obtained.

The internal combustion engine preferably has at least one combustion chamber, particularly preferredly a plurality of combustion chambers, wherein to the at least one combustion chamber is assigned a gas injection valve according to one of the previously described illustrative embodiments. In particular, it is possible that to each combustion chamber of a plurality of combustion chambers is respectively assigned a separate gas injection valve, which in particular is actuatable independently of the other gas injection valves. It is also possible, however, that to a plurality of combustion chambers, for instance a combustion chamber assembly or cylinder bank, is assigned a common gas injection valve.

The gas injection valve can be designed and arranged on the internal combustion engine to realize a single-point injection, or else a direct injection, of combustion gas.

The internal combustion engine is preferably configured as a reciprocating piston engine. It is possible that the internal combustion engine is designed to drive a passenger vehicle, a truck or a commercial vehicle. In a preferred illustrative embodiment, the internal combustion engine serves for the driving of, in particular, heavy duty land vehicles or watercraft, for instance of mining vehicles, trains, wherein the internal combustion engine is used in a locomotive or a railcar, or of ships. Use of the internal combustion engine to drive a defense vehicle, for example a tank, is also possible. An illustrative embodiment of the internal combustion engine is preferably also used stationary, for instance for the stationary energy supply in emergency power supply mode, continuous load operation or peak load operation, wherein the internal combustion engine, in this case, preferably drives a generator. A stationary application of the internal combustion engine for the driving of auxiliary units, for instance of fire-extinguishing pumps on oil rigs, is also possible. Furthermore, an application of the internal combustion engine in the field of extraction of fossil raw materials and, in particular, fuels, for instance oil and/or gas, is possible. A use of the internal combustion engine in the industrial sector or in the construction sector, for instance in a construction machine or building machine, for example in a crane or excavator, is also possible. The internal combustion engine is preferably configured as a diesel engine, as a petrol engine, as a gas engine for operation with natural gas, biogas, special gas, or another suitable gas. In particular where the internal combustion engine is configured as a gas engine, it is suitable for use in a combined heat and power plant for stationary power generation.

Finally, the object is also achieved by the provision of a method for operating an internal combustion engine having a gas injection valve according to one of the previously described illustrative embodiments. A gas quantity to be injected is here set on an operating-point-dependent basis by adjustment of the maximum stroke of the valve member of the gas injection valve. At the same time, actuation times, that is to say in particular energization times, are preferably chosen for the gas injection valve on an operating-point-dependent basis for an optimized mixture formation in at least one combustion chamber of the internal combustion engine. In connection with the method, in particular the advantages which have already been described in connection with the gas injection valve are obtained.

By an operating-point-dependent adjustment is in particular understood an adjustment which is dependent on an operating point of the internal combustion engine, in particular on a load point of this same, preferably, in particular, on current torque, on the one hand, and current rotation speed, on the other hand. Because the maximum stroke of the gas injection valve is adjustable, and hence is available as a parameter for the adjustment of the combustion gas quantity to be injected, it is possible to choose the actuation times for the gas injection valve in particular without regard to the combustion gas quantity to be injected, and rather to vary these with a view to an optimized mixture formation in the at least one combustion chamber. By actuation times are here understood, in particular, an energization start, an energization end, and/or an energization period for the gas injection valve, in particular for the first displacement mechanism.

According to a refinement of the invention, it is provided that upstream of the gas injection valve, in particular directly upstream thereof, in a combustion gas line of the internal combustion engine, a combustion gas pressure—which is constant over time and, in particular, independently of the operating point—is set. A constant combustion gas pressure is here, in particular, a combustion gas pressure which does not vary in dependence on instantaneous operating point of the internal combustion engine. A complex gas pressure regulation can herein be avoided, rather a simple fixed pressure regulator is sufficient for the constant regulation of the combustion gas pressure.

For the adjustment or regulation of the maximum stroke and of the resulting flow cross-section and/or static flow rate of the gas injection valve, the combustion gas quantity, in particular combustion gas mass, which is calculated on an operating-point-dependent basis, that is to say in particular as a function of current rotation speed and current load of the internal combustion engine, is preferredly used. It is here possible to determine the maximum stroke, and hence the current stroke height, for the valve member, with due regard to the primary pressure in the combustion gas line, a counterpressure, measured in the charging path, for the combustion gas, thus, in particular, a boost pressure, preferably measured in the inlet manifold, and a—preferably measured—current combustion gas pressure, wherein the maximum stroke is preferably read off from a valve characteristic diagram. In the valve characteristic diagram, in particular a flow rate of the gas injection valve can be stored as a function of the maximum stroke. From the combustion gas quantity which is required in dependence on the operating point, the flow rate to be set, and hence also the stroke height to be set—that is to say the maximum stroke—can be calculated with due regard to the previously stated parameters.

According to a refinement of the invention, it is provided that an internal combustion engine is operated with a plurality of combustion chambers. To each combustion chamber or to each combustion chamber assembly of a plurality of combustion chamber assemblies, for instance cylinder banks, is here assigned a gas injection valve—which is preferably separate and, in particular, is actuatable independently of the other gas injection valves. The actuation times and/or the maximum stroke is/are here set separately for each gas injection valve. In this way, said parameters, that is to say in particular the actuation times and/or the maximum stroke, can be used to equalize the various combustion chambers of the internal combustion engine. In particular, it is possible, by an averaging of the combustion periods of all combustion chambers and of appropriate correction of every gas injection valve to this average value, to obtain an equalization of the combustion chambers. A particularly smooth and balanced engine running can thus be realized for the internal combustion engine.

The here proposed combustion gas valve, the internal combustion engine and the method enable, in particular, an improved engine running combined with reduced emissions, in particular at idle, under full load and also in the event of a power boost, as well as in other areas of the engine characteristic diagram. An improved long-term stability is obtained, in particular since effects of wear can be offset by adjustment of the maximum stroke. A complex gas pressure regulation can be avoided, rather it is sufficient to provide a fixed pressure regulator for regulating the primary pressure of the combustion gas. For the at least one gas injection valve of the internal combustion engine, optimal energization times can be set with a view to a suitable running of the internal combustion engine, and this both at idle and under full load.

The description of the gas injection valve and of the internal combustion engine, on the one hand, and of the method, on the other hand, should be understood to be mutually complementary. Features of the gas injection valve and of the internal combustion engine which are explicitly or implicitly described in connection with the method are preferredly individual or mutually combined features of a preferred illustrative embodiment of the gas injection valve and/or of the internal combustion engine. Method steps which are explicitly or implicitly described in connection with the gas injection valve or the internal combustion engine are preferredly individual or mutually combined features of a preferred embodiment of the method. This is distinguished by at least one method step which is conditioned by at least one feature of an illustrative embodiment according to the invention, or a preferred illustrative embodiment, of the gas injection valve or of the internal combustion engine. The gas injection valve and/or the internal combustion engine is/are preferredly distinguished by at least one feature which is conditioned by at least one step of an embodiment according to the invention, or of a preferred embodiment, of the method.

The invention is explained in greater detail below on the basis of the drawing. The single FIGURE here shows a schematic representation of an illustrative embodiment of an internal combustion engine having a gas injection valve.

The single FIGURE shows a schematic representation of an illustrative embodiment of an internal combustion engine 1 having a gas injection valve 3. The gas injection valve 3 is designed to inject a combustion gas into the internal combustion engine 1. It has a valve member 5, which is displaceable between a closed position, in which a flow path for combustion gas is closed by the gas injection valve 3, and an open position, defined by a maximum stroke of the valve member 5, in which a flow path for combustion gas is opened up by the gas injection valve 3. It is here provided that the maximum stroke of the valve member 5 is adjustable during operation of the gas injection valve 3. In this way, the adjustment of the maximum stroke of the valve member 5 can be used as a parameter for the quantity control of a combustion gas quantity to be injected into the internal combustion engine 1. This enables, in particular, a choice of energization or actuation times for the gas injection valve 3 independently of the combustion gas quantity to be injected, so that this can rather be chosen such that it is in particular optimized to a mixture formation into a combustion chamber 7 of the internal combustion engine 1. Moreover, a complicated regulation of a primary pressure for the combustion gas can be dispensed with, rather it is possible, upstream of the gas injection valve 3, to set a constant combustion gas pressure which is, in particular, independent of the operating point, since this is no longer required as a parameter for the quantity control. Furthermore, ageing effects of a charging path 9 of the internal combustion engine 1 and/or of the gas injection valve 3 can be offset by variation of the maximum stroke.

The gas injection valve 3 has a first stop 11, against which the valve member 5, in the open position, butts. The first stop 11 here defines the maximum stroke, wherein it is displaceable, viewed in the stroke direction of the valve member 5, relative to a housing 13 of the gas injection valve 3, which housing can be disposed, in particular in an engine-mounted manner, on the internal combustion engine 1. In particular, the first stop 11 is displaceable between a minimum position, represented in the FIGURE, which defines a minimal maximum stroke, and a maximum position, which defines a maximal maximum stroke for the valve member 5.

The first stop 11 is disposed on a stop member 15, which is displaceable between a second stop 17, which is arranged in a spatially fixed manner relative to the housing 13, and a third stop 19, which is arranged in a spatially fixed manner relative to the housing 13. The second stop 17 and the third stop 19 are here preferably disposed on the housing 13. The second stop 17 defines the minimum position for the first stop 11, wherein the third stop 19 defines the maximum position for the first stop 11.

The gas injection valve 3 additionally has a fourth stop 21, which is preferredly configured as a sealing seat for the valve member 5.

The gas injection valve 3 here has a first displacement mechanism 23 for the displacement of the valve member 5 between the closed position and the open position, and a second displacement mechanism 25 for the displacement of the first stop 11, in particular of the stop member 15, between the minimum position and the maximum position. The first displacement mechanism 23 is preferably of electromagnetic configuration, wherein it has, in particular, an electromagnet 27, wherein the electromagnet 27 is preferably disposed on the stop member 15 or configured as a stop member 15, and, in particular, is displaceable with the stop member 15, and has an armature 29, which is disposed on the valve member 5.

It is also possible that the valve member 5 is configured as an armature 29. The armature is in particular a magneto armature, which is displaceable by the electromagnet 27. If the electromagnet 27 is energized, the armature 29, and hence the valve member 5, starting from the functional position represented in the FIGURE, is raised in the direction of the electromagnet 27, preferably to the point at which the valve member 5 butts against the first stop 11. The first stop 11 thus defines a maximum stroke position of the valve member 5, which is achievable with the first displacement mechanism 23 at current position of the first stop 11, and hence defines the maximum stroke, as well as the open position.

The second displacement mechanism 25 preferably has an actuatable rotary drive 31, which is preferably configured as an electric motor, wherein the rotary drive 31 cooperates with a thread 33, which in particular is configured as a fine-pitch thread, in order to adjust the first stop 11.

The gas injection valve 3 has, in particular, the adjusting element 35, which is displaceable jointly with the stop member 15 and which has a thread 33.1, here namely an external thread, that meshes with a second thread 33.2, which is arranged in a spatially fixed manner relative to the housing 13 and which here in particular is configured as an internal thread, wherein the rotary drive 31 is designed and arranged to rotationally drive the adjusting element 35. In this case, the stop member 15 is here configured as an adjusting element 35. Alternatively, it is also possible that the adjusting element 35 is disposed on the stop member 15 or is part of the stop member 15.

If the adjusting element 35 is rotated by the rotary drive 31, its first thread cooperates 33.1 with the second thread 33.2, so that the stop member 15 is displaced, together with the first stop 11, in the stroke direction of the valve member 5. In this case, the unit comprising the rotary drive 31 and the stop member 15 can here be displaced between the second stop 17 and the third stop 19, whereby the first stop 11 is displaced between the minimum position and the maximum position. In this way, by actuation of the rotary drive 31, the maximum stroke of the gas injection valve 3 is adjustable. This can be done, in particular, during the operation of the gas injection valve 3, and hence also of the internal combustion engine 1, wherein an adjustment of the maximum stroke, preferably on a time scale of less than 1 second, is possible. A fully transient operation of the internal combustion engine 1, with variation of the maximum stroke, can thus be ensured.

Within a method for operating the internal combustion engine 1 with the gas injection valve 3, a gas quantity, to be injected, of the combustion gas is set on an operating-point-dependent basis, that is to say in dependence on instantaneous operating point of the internal combustion engine 1, by adjustment of the maximum stroke of the valve member 5. At the same time, actuation times or energization times for the gas injection valve 3 are preferredly chosen on an operating-point-dependent basis, that is to say in dependence on an instantaneous operating point of the internal combustion engine 1, with a view to an optimized mixture formation in the at least one combustion chamber 7 of the internal combustion engine 1. It is here preferredly provided that, upstream of the gas injection valve 3 in a combustion gas supply line 37 of the internal combustion engine 1, is set a constant combustion gas pressure, which accordingly, in particular, is not varied in dependence on an operating point of the internal combustion engine 1.

Preferably, an internal combustion engine 1 is operated with a plurality of combustion chambers 7, wherein to each combustion chamber 7 or to each combustion chamber assembly of combustion chambers 7 is assigned an, in particular separate, gas injection valve 3. The actuation times or energization times for the gas injection valves 3, and/or the maximum stroke of the valve member 5, are set separately for each gas injection valve 3 of the internal combustion engine 1. In this way, in particular an equalization of the combustion chambers for the internal combustion engine 1 can be performed.

The gas injection valve 3 is preferredly designed for multipoint injection or single-point injection into the charging path 9 of the internal combustion engine 1. It is also possible, however, that the gas injection valve 3 is designed for the direct injection of combustion gas into the combustion chamber 7.

Overall, it turns out that, with the here proposed gas injection valve 3, the internal combustion engine 1 and the method for operating the internal combustion engine 1, an improved engine running with improved emissions, in particular combined with improved no-load operation, unrestricted full-load operation and improved power boost, is realized. An improved long-term stability both of the gas injection valve 3 and of the internal combustion engine 1 is here also achieved, wherein a wearing of the charging path 9 and/or of the gas injection valve 3 can be offset by suitable adjustment of the maximum stroke. Due to the maximum stroke as an additional parameter for the quantity control of the combustion gas quantity to be injected, an optimal energization period for the gas injection valve 3 throughout the operating range of the internal combustion engine 1 can be set, wherein the energization times can differ in dependence on the operating point. In particular optimal energization times can here respectively be chosen for a no-load operation and for a full-load operation of the internal combustion engine 1.

1-10. (canceled)

11. A gas injection valve for injecting a combustion gas into an internal combustion engine, comprising:
a valve member displaceable between a closed position and an open position defined by a maximum stroke of the valve member,
wherein the maximum stroke of the valve member is adjustable during operation of the gas injection valve.

12. The gas injection valve according to claim 11, further comprising a housing and a first stop, against which the valve member, in the open position, butts, wherein the first stop defines the maximum stroke, and wherein the first stop is displaceable, viewed in a stroke direction of the valve member, relative to the housing.

13. The gas injection valve according to claim 12, further comprising a stop member, wherein the first stop is disposed on the stop member, wherein the stop member is displaceable between a second stop, arranged in a spatially fixed manner relative to the housing, and a third stop, arranged in a spatially fixed manner relative to the housing, wherein the second stop defines a minimum position for the first stop, and the third stop defines a maximum position for the first stop.

14. The gas injection valve according to claim 13, further comprising a first displacement mechanism for displacement of the valve member between the closed position and the open position, and a second displacement mechanism for displacement of the first stop.

15. The gas injection valve according to claim 14, wherein the second displacement mechanism includes an actuatable rotary drive that cooperates with a thread for adjustment of the first stop.

16. The gas injection valve according to claim 15, further comprising an adjusting element that is displaceable jointly with the stop member and has a first thread that meshes with a second thread arranged in a spatially fixed manner relative to the housing, wherein the rotary drive is configured and arranged to rotationally drive the adjusting element.

17. An internal combustion engine, comprising a gas injection valve according to claim 11.

18. A method for operating an internal combustion engine having a gas injection valve according to claim 11, comprising the steps of:
setting a combustion gas quantity to be injected on an operating-point-dependent basis by adjusting a maximum stroke of a valve member of the gas injection valve; and,
choosing actuation times for the gas injection valve on an operating-point-dependent basis for an optimized mixture formation in at least one combustion chamber of the Internal combustion engine.

19. The method according to claim 18, including setting a constant combustion gas pressure, upstream of the gas injection valve, in a combustion gas supply line of the internal combustion engine.

20. The method according to claim 18, including operating the internal combustion engine with a plurality of combustion chambers, and assigning a gas injection valve to each combustion chamber or to each combustion chamber assembly of a plurality of combustion chamber assemblies of the internal combustion engine, wherein
actuation times and/or
maximum stroke
is/are set separately for each gas injection valve.
